(19) United States
(12) Patent Application Publication
(10) Pub. No.: US 2019/0176269 A1
(43) Pub. Date: Jun. 13, 2019

(54) LASER ENGRAVING DEVICE

(71) Applicant: ASTI GLOBAL INC., TAIWAN, Changhua County (TW)

(72) Inventor: CHIEN-SHOU LIAO, New Taipei City (TW)

(21) Appl. No.: 16/214,447

(22) Filed: Dec. 10, 2018

(30) Foreign Application Priority Data
Dec. 11, 2017 (TW) 106143363

(51) Int. Cl. B23K 26/362; B23K 26/00; B23K 26/03; B23K 26/04; B23K 26/06; B23K 26/70

(52) U.S. Cl. CPC B23K 26/362; B23K 26/0006; B23K 26/032; B23K 26/0344; G02B 5/04; B23K 26/0608; B23K 26/0652; B23K 26/04; B23K 26/702; B23K 26/043

(57) ABSTRACT

A laser engraving device includes a carrier substrate, a position detecting module, and a laser engraving module. The carrier substrate is used to carry at least one wafer, and the at least one wafer has a first engraving area formed thereon. The position detecting module includes a first transmitting component and a first receiving component. The laser engraving module includes a first laser generator to provide a first laser light source. The position detecting module can provide a first position signal of the first engraving area by matching the first transmitting component and the first receiving component. Therefore, the light from the first laser light source generated by the first laser generator can be precisely projected onto the first engraving area of the at least one wafer according to the first position signal so as to form a first predetermined pattern on the first engraving area.

### CROSS-REFERENCE TO RELATED PATENT APPLICATION

This application claims the benefit of priority to Taiwan Patent Application No. 106143363, filed on 11, Dec. 2017. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an engraving device, and more particularly to a laser engraving device.

### BACKGROUND OF THE DISCLOSURE

Electronic equipment using semiconductor devices is important for modern technology applications. With the advancement of electronic technology, the size of semiconductor devices has become smaller and smaller, while semiconductor devices can also provide better functions and contain more integrated circuits. Due to the miniaturization of semiconductor devices, the method of Wafer-level chip packaging (WLCSP) is widely used for its low cost and relatively simple manufacturing operations. During WLCSP operations, some semiconductor components are assembled on a semiconductor device. Furthermore, many manufacturing operations will be performed on this small semiconductor device.

However, since many manufacturing steps and operations of semiconductor devices are performed on small and thin wafers, in the process of laser engraving patterns, for example, warpage problems tend to occur on small and thin wafers, so that the pattern formed by laser engraving on the wafer will be unclear and cause distortion problems.

### SUMMARY OF THE DISCLOSURE

In response to the above-referenced technical inadequacies, the present disclosure provides a laser engraving device capable of forming a clear and undistorted predetermined pattern on an engraved area of at least one of the wafers.

In one aspect, the present disclosure provides a technical solution of a laser engraving device for engraving on at least one wafer. The laser engraving device includes: a carrier base, a position detecting module and a laser engraving module. The carrier base is configured to carry at least one of the wafers, and an upper surface of at least one of the wafers has a first engraved area. The position detecting module includes a first transmitting component and a first receiving component, and both are disposed above the carrier base. The laser engraving module includes a first laser generator disposed above the carrier base to provide a first laser source. The position detecting module cooperates with the first receiving component to provide a first position information of the first engraved area. The light emitted from the first laser light source provided by the first laser generator is precisely projected onto the first engraved area of at least one of the wafers according to the first position information, so as to form a first predetermined pattern on the first engraved area.

In one aspect, the present disclosure provides a technical solution of a laser engraving device for engraving on at least one wafer. The laser engraving device includes: a carrier base, a first transmitting component, a first receiving component, and a control module. The carrier base is configured to carry at least one of the wafers, and an upper surface of at least one of the wafers has a first engraved area. The first transmitting component is disposed above the carrier base to provide a first laser source. The first receiving component is disposed above the carrier base. The control module is electrically connected between the first transmitting component and the first receiving component. The light emitted from the first laser light source provided by the first transmitting component is projected to the first receiving component by reflection of at least one of the wafers to provide a first position information of the first engraved area. The first laser light source provided by the first transmitting component is precisely projected onto the first engraved area of at least one of the wafers according to the first position information, so as to form a first predetermined pattern on the engraved area.

In one aspect, the present disclosure provides a technical solution of a laser engraving device for engraving on at least one wafer. The laser engraving device includes: a carrier base, a position detection module and a laser engraving module. The carrier base is configured to carry at least one of the wafers, and at least one of the wafers has a first engraved area. The position detecting module includes a first transmitting component and a first receiving component. The laser engraving module includes a first laser generator that provides a first laser source. The position detecting module cooperates with the first receiving component to provide a first position information of the first engraved area. The light emitted from the first laser light source provided by the first laser generator is precisely projected onto the first engraved area of at least one of the wafers according to the first position information, so as to form a first predetermined pattern on the first engraved area.

The laser engraving device of the present disclosure has the following advantages. By adopting the technical feature of “the position detecting module cooperates with the first receiving component to provide a first position information of the first engraved area,” the light emitted from the first laser source provided by the first laser generator can precisely project to at least one of the first engraving regions of the wafer according to the first position information, so as to form a first predetermined pattern on the first engraving region.

Furthermore, by adopting the technical feature of “the light emitted from the first laser light source provided by the first transmitting component is projected to the first receiving component by reflection of at least one of the wafers to provide a first position information of the first engraved area,” the first laser light source provided by the first transmitting component can be precisely projected onto the first engraved area of at least one of the wafers according to the first position information, so as to form a first predetermined pattern on the first engraved area

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view showing a laser engraving device according to a first embodiment of the present disclosure cooperating with a first receiving component to obtain a first position information of a first engraved area.

FIG. 2 is a schematic view showing the laser engraving device according to the first embodiment of the present disclosure precisely projecting the light emitted from a first laser light source of the laser engraving device onto the first engraved area of a wafer according to the first position information.

FIG. 3 is a functional block diagram of the laser engraving device according to the first embodiment of the present disclosure.

FIG. 4 is a schematic view showing the laser engraving device according to a second embodiment of the present disclosure cooperating with a first receiving component to obtain the first position information of a first engraved area, and a second transmitting component cooperating with a second receiving component to obtain a second position information of the second engraved area.

FIG. 5 is a schematic view showing the light emitted from the first laser light source of the laser engraving device of the laser engraving device according to a second embodiment of the present disclosure being precisely projected onto the first engraved area of the wafer according to the first position information, and the light emitted from a second laser light source being precisely projected onto the second engraved area of the wafer according to the second position information.

FIG. 6 is a schematic view showing the laser engraving device according to a third embodiment of the present disclosure cooperating with the first receiving component to obtain a first position information of the first engraved area.

FIG. 7 is a schematic view showing the light emitted from the first laser light source of the laser engraving device of the laser engraving device according to a third embodiment of the present disclosure being precisely projected onto the first engraved area of the wafer according to the first position information.

FIG. 8 is a contour map drawn by the surface undulation information of the first engraved area according to one of the embodiments.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

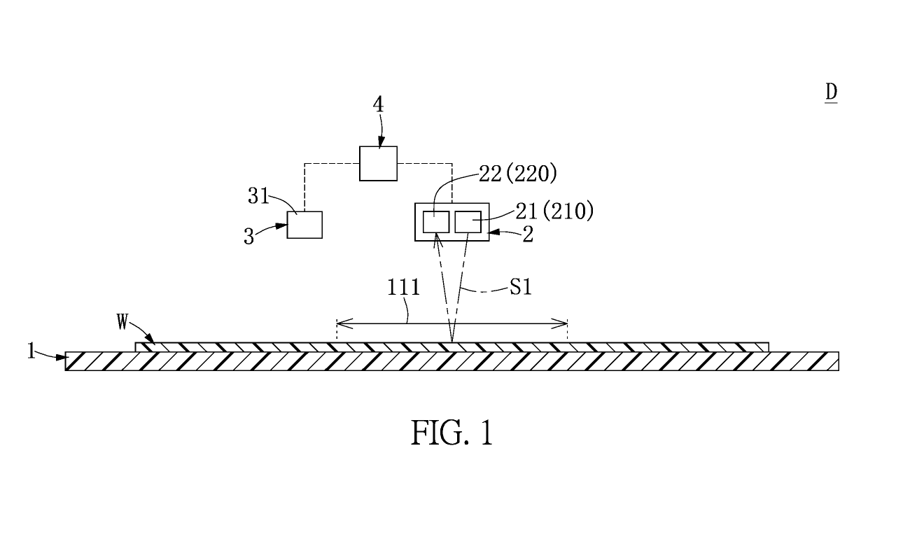

Referring to FIG. 1 to FIG. 3, a first embodiment of the present disclosure provides a laser engraving device D. The laser engraving device D can be used to engrave patterns on a wafer W, and the laser engraving device D includes a carrier base 1, a position detecting module 2 and a laser engraving module 3.

First, as shown in FIG. 1, the carrier base 1 can be used to carry the wafer W, and the upper surface of the wafer W has a first engraved area 111. For example, the wafer W can also be replaced with any semiconductor wafer, therefore, the present disclosure is not limited to engraving the pattern on the wafer W.

Furthermore, as shown in FIG. 1, the position detecting module 2 includes a first transmitting component 21 and a first receiving component 22, both disposed above the carrier base 1. For example, the position detecting module 2 can be a detecting module for measuring the surface undulation state, such as an optical position sensor or an acoustic wave position sensor. However, the present disclosure is not limited thereto.

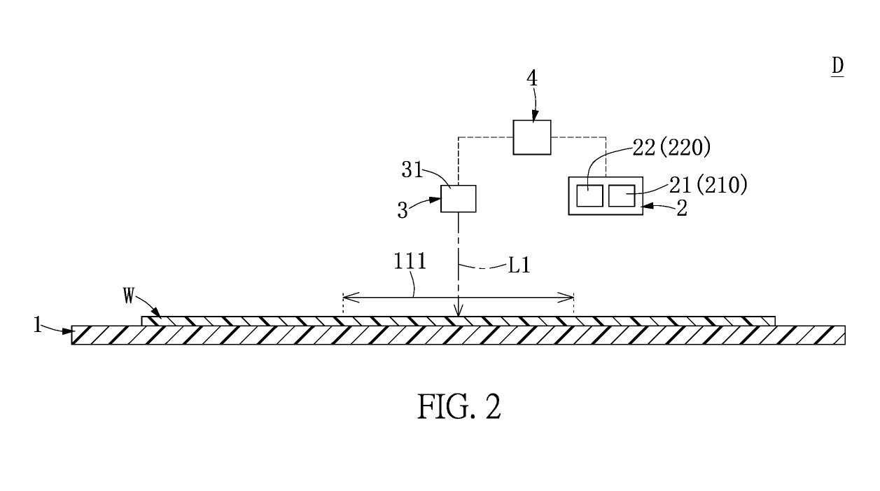

In addition, as shown in FIG. 1 and FIG. 2, the laser engraving module 3 includes a first laser generator 31 disposed above the carrier base 1 to provide a first laser light source L1. Furthermore, as shown in FIG. 1, the position detecting module 2 cooperates with the first receiving component 22 to provide a first position information of the first engraved area 111. In addition, as shown in FIG. 2, the laser engraving device D moves forward, and the light emitted from the first laser light source L1 provided by the first laser generator 31 can precisely project onto the wafer W on the first engraved area 111 according to the first position information, so as to form a first predetermined pattern on the first engraved area 111.

For example, as shown in FIG. 1, the first transmitting component 21 can be a first signal transmitting component 210 (e.g., a signal transmitter) generating a first detecting signal S1 (e.g., a light wave signal or an acoustic wave signal). The first receiving component 22 can be a first signal receiving component 220 (e.g., a signal receiver) receiving the first detecting signal S1. Thereby, the first detecting signal S1 generated by the first signal transmitting component 210 can be projected to the first signal receiving component 220 by reflection of the wafer W to provide first position information of the first engraving region 111. Next, as shown in FIG. 2, the laser engraving device D moves forward, and then the light emitted from the first laser light source L1 is precisely projected onto the first engraved area 111 according to the first position information, so as to engrave a first predetermined pattern on the 111 in the first engraved area. According to different needs, the first predetermined pattern can be one of a mark, a trademark, a serial number, and a barcode. However, the present disclosure is not limited thereto.

In conclusion, even if at least one wafer W causes the first engraved area 111 to be in a non-flat state due to warpage, the present disclosure can obtain a first position information of the 111 (that is, surface undulation information of the first engraved area 111) of the first engraved area by the mutual cooperation of the first transmitting component 21 and the first receiving component 22 in advance. The light emitted from the first laser light source L1 can be precisely projected onto the first engraved area 111 according to the first position information, so as engraved an undistorted and clear first predetermined pattern is on an engraved area 111.

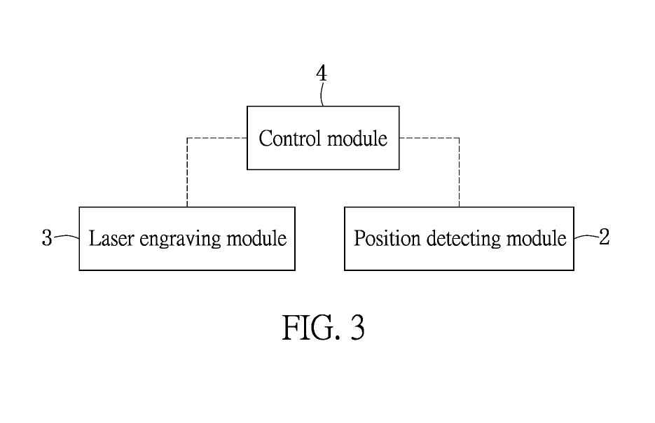

It should be noted that, as shown in FIG. 3, the laser engraving device D further includes a control module 4, and the control module 4 is electrically connected to the position detecting module 2 and the laser engraving module 3.

### Second Embodiment

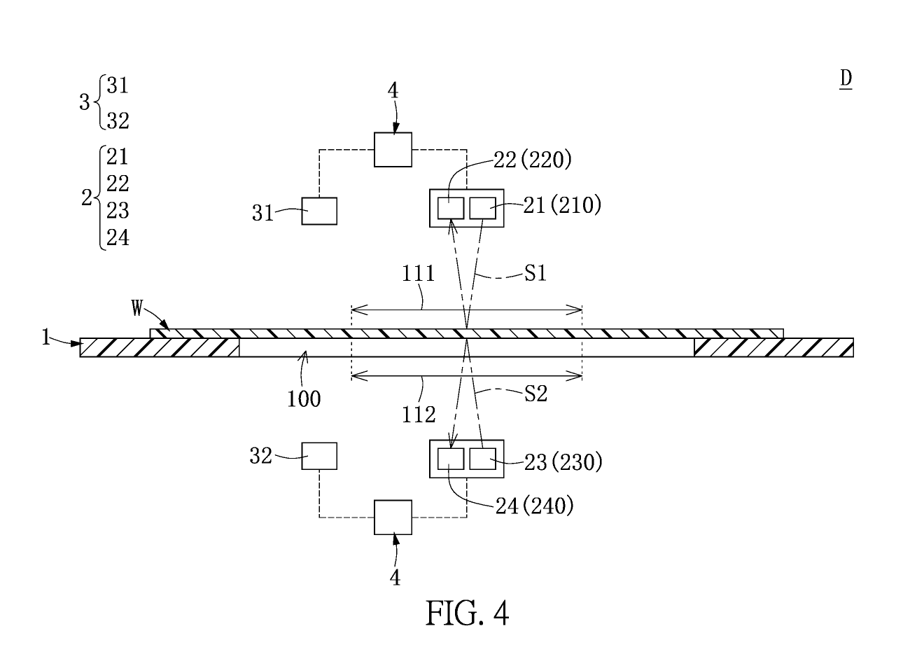

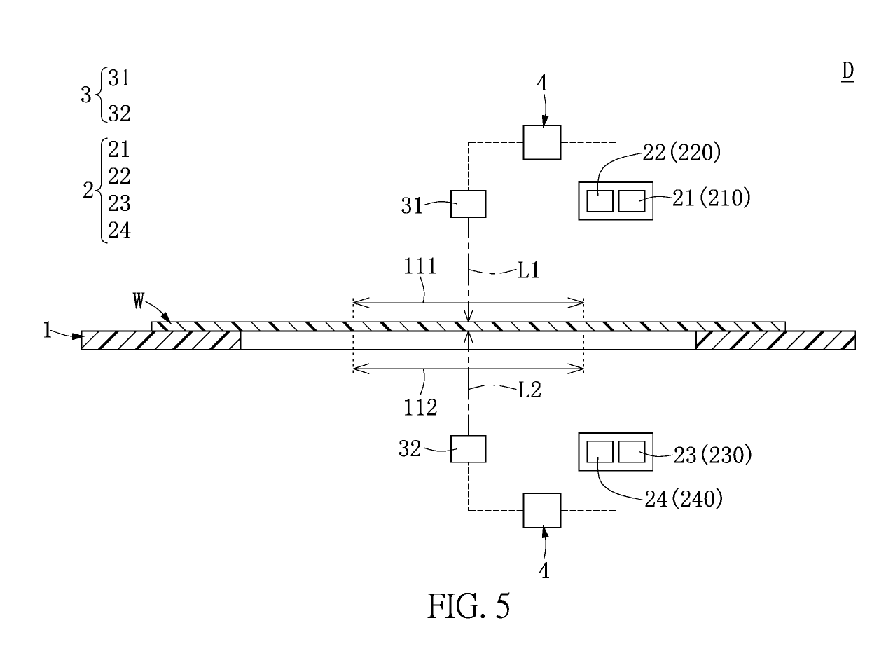

Referring to FIG. 4 to FIG. 5, a second embodiment of the present disclosure provides a laser engraving device D. The laser engraving device D can be used to engrave patterns on at least one wafer W, and the laser engraving device D includes a carrier base 1, a position detecting module 2 and a laser engraving module 3. In comparison with FIG. 4 and FIG. 1 and in comparison with FIG. 5 and FIG. 2, the greatest difference between the first embodiment and the second embodiment is that:

First, as shown in FIG. 4, the carrier base 1 has a through opening 100, and the lower surface of at least one wafer W has a second engraved area 112 disposed opposite to the first engraved area 111, and the second engraved area 112 are exposed by the through opening 100. In addition, the position detecting module 2 includes a second transmitting component 23 and a second receiving component 24, and the second transmitting component 23 and the second receiving component 24 are disposed under the carrying base 1.

Furthermore, as shown in FIG. 4 and FIG. 5, the laser engraving module 3 includes a second laser generator 32 disposed below the carrier base 1 to provide a second Laser source L2 passing through the through opening 100. Furthermore, as shown in FIG. 4, the position detecting module 2 cooperates with the second receiving component 24 to provide a second position information of the second engraved area 112. In addition, as shown in FIG. 5, the laser engraving device D moves forward, and then the light emitted from the second laser light source L2 provided by the second laser generator 32 can precisely project to at least one wafer W on the second engraved area 112 according to the second position information, so as to form a second predetermined pattern on the second engraved area 112.

In addition, as shown in FIG. 1 and FIG. 2, the laser engraving module 3 includes a first laser generator 31 disposed above the carrier base 1 to provide a first laser light source L1. Furthermore, as shown in FIG. 1, the position detecting module 2 can cooperate with the first receiving component 22 to provide a first position information of the first engraved area 111. In addition, as shown in FIG. 2, the laser engraving device D moves forward, and the light emitted from the first laser light source L1 provided by the first laser generator 31 can precisely project onto at least one wafer W on the first engraved area 111 according to the first position information, so as to form a first predetermined pattern on the first engraved area 111.

For example, as shown in FIG. 1, the first transmitting component 21 can be a first signal transmitting component 210 (e.g., a signal transmitter) generating a first detecting signal S1 (e.g., a light wave signal or an acoustic wave signal). The first receiving component 22 can be a first signal receiving component 220 (e.g., a signal receiver) receiving the first detection signal S1. Thereby, the first detection signal S1 generated by the first signal transmitting component 210 can be projected to the first signal receiving component 220 by reflection of at least one wafer W to provide first position information of the first engraving region 111. Next, as shown in FIG. 2, the laser engraving device D moves forward, and then the light emitted from the first laser light source L1 is precisely projected onto the first engraved area 111 according to the first position information, so as to engrave a first predetermined pattern on the 111 in the first engraved area. According to different needs, the first predetermined pattern may be one of a mark, a trademark, a serial number, and a barcode. However, the present disclosure is not limited thereto.

In conclusion, even if at least one wafer W causes the second engraved area 112 to be in a non-flat state due to warpage, the present disclosure can obtain a second position information of the second engraved area 112 (that is, the surface undulation information of the second engraved area 112) in advance by the cooperation of the second transmitting component 23 and the second receiving component 24. Then, the light emitted from the second laser light source L2 can be precisely projected onto the second engraved area 112 according to the second position information, so as to engrave an undistorted and clear second predetermined pattern on the engraved area 112.

### Third Embodiment

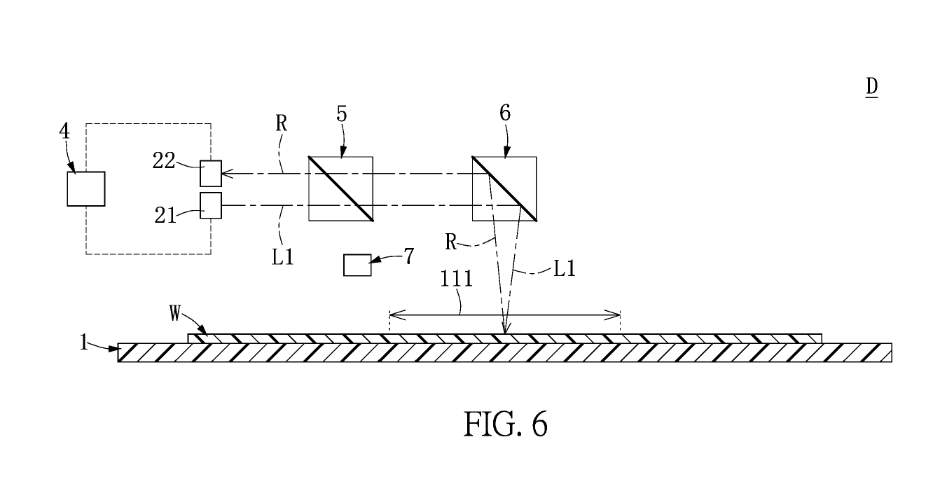

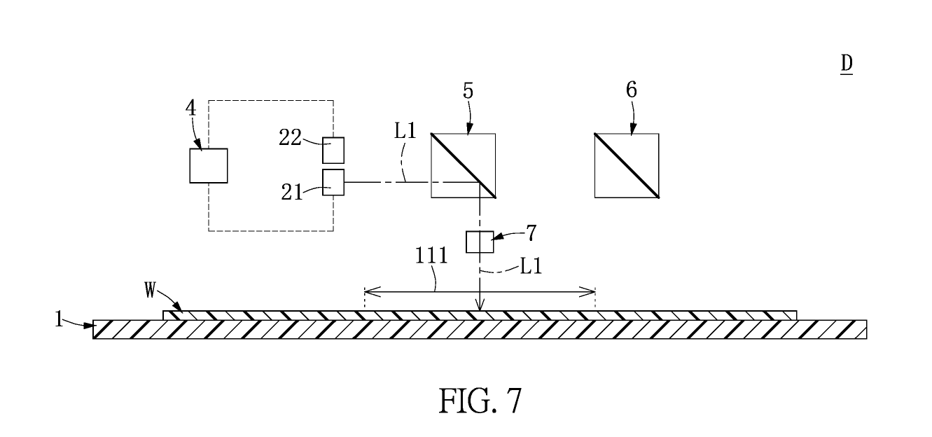

Referring to FIG. 6 to FIG. 7, a third embodiment of the present disclosure provides a laser engraving device D. The laser engraving device D can be used to engrave patterns on a wafer W, and the laser engraving device D includes a carrier base 1, a first transmitting component 21, a first receiving component 22, and a control module 4. The carrier base 1 is used to carry the wafer W, and the upper surface of the wafer W has a first engraved area 111. The first transmitting component 21 is disposed above the carrier base 1 to provide a first laser light source L1. The first receiving component 22 is disposed above the carrier base 1. The control module 4 is electrically connected between the first transmitting component 21 and the first receiving component 22.

Further, as shown in FIG. 6, the light emitted from the first laser light source L1 provided by the first transmitting component 21 can be projected to the first receiving component 22 by reflection of the wafer W to provide a first position information of the first engraved area 111. In addition, as shown in FIG. 7, the light emitted from the first laser light source L1 provided by the first transmitting component 21 can be precisely projected onto the first engraved area 111 of the wafer W according to the first position information, so as to form (engrave) a first predetermined pattern on the first engraved area 111.

For example, as shown in FIG. 6 and FIG. 7, the laser engraving apparatus D further includes: a first prism 5, a second prism 6, and a signal amplifier 7. The first prism 5 is adjacent to the first transmitting component 21 and the first receiving component 22. The second prism 6 is adjacent to the first prism 5. The signal amplifier 7 is adjacent to the first prism 5. Further, as shown in FIG. 6, the light emitted from the first laser light source L1 generated by the first transmitting component 21 is sequentially projected to the wafer W through the first prism 5 and the second prism 6. After the light emitted from the first laser light source L1 is reflected by at least one wafer W, a reflective light source R is formed, and the light emitted from the reflected light source R is sequentially projected to the first receiving component 22 through the second prism 6 and the first prism 5 to obtain the first position information of the first engraved area 111. In addition, as shown in FIG. 7, the laser engraving device D moves forward, and the light emitted from the first laser light source L1 generated by the first transmitting component 21 will sequentially project through the first prism 5 and the signal amplifier 7 to precisely project to at least a first engraved area 111 of a wafer W to engrave a first predetermined pattern on the first engraved area 111.

In conclusion, even if at least one wafer W causes the first engraved area 111 to be in a non-flat state due to warpage, the present disclosure can obtain a first position information of the first engraved area 111 (that is, the surface undulation information of the second engraved area 111). Then, the first laser light source L1 can be precisely projected onto the first engraved area 111 according to the first position information so as to engrave an undistorted and clear first predetermined pattern on the first engraved area 111.

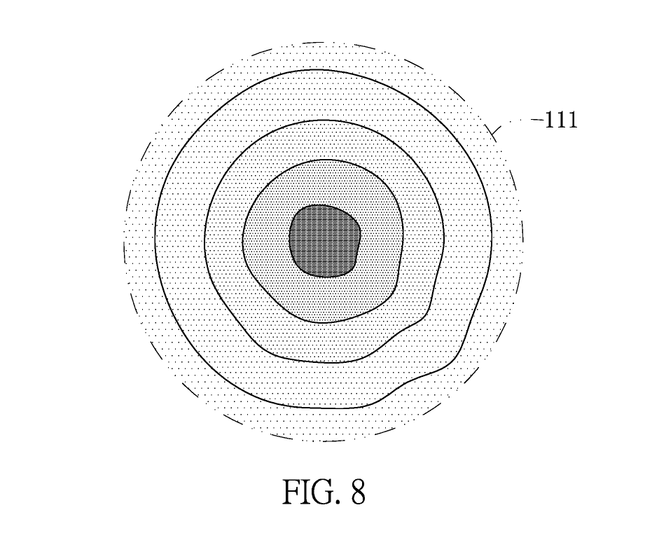

It should be noted that, in the first to third embodiments, the light from the first laser light source L1 provided by the first transmitting component 21 can be projected to the first receiving component 22 through the reflection of the wafer W to provide the surface undulation information of the first engraved area 111 of the wafer W. A contour map (such as but not limited to one shown in FIG. 8) can be drawn after collecting the surface undulation information of the first engraved area 111, and the light emitted from the first laser light source L1 can be quickly and precisely projected onto the first engraved area 111 according to the contour map, so as to engrave a clear and accurate first predetermined pattern on the first engraved area 111.

In conclusion, the present disclosure provides a laser engraving device D, includes: a carrier base 1, a position detecting module 2 and a laser engraving module 3. The carrier base 1 is used to carry a wafer W, and the wafer W has a first engraved area 111. The position detecting module 2 includes a first transmitting component 21 and a first receiving component 22. The laser engraving module 3 includes a first laser generator 31 to provide a first laser source L1. Thereby, the position detecting module 2 can cooperate with the first receiving component 22 to provide a first position information of the first engraved area 111. In addition, the light emitted from the first laser light source L1 provided by the first laser generator 31 can be precisely projected onto the first engraved area 111 of the at least one wafer W according to the first position information, so as form a first predetermined pattern on the first engraved area 111.

By adopting the technical feature of “the light emitted from the first laser light source L1 provided by the first transmitting component 21 is projected to the first receiving component 22 by reflection of the wafer W to provide the first position information of the first engraved area 111,” the laser engraving device D provided by the present disclosure can have the advantage that the light emitted by the first laser light source L1 provided by the first transmitting component 31 can be precisely projected onto the first engraved area 111 of the at least one wafer W according to the first position information, so as to form the first predetermined pattern on the first engraved area 111.

Furthermore, by adopting the technical feature of “the light emitted from the first laser light source L1 provided by the first transmitting component 21 is projected to the first receiving component 22 by reflection of at least one wafer W to provide a first position information of the first engraved area 111”, the light emitted by the first laser light source L1 provided by the first transmitting component 31 can be precisely projected onto the first engraved area 111 of the at least one wafer W according to the first position information, so as to form the first predetermined pattern on the first engraved area 111.

Therefore, even if the wafer W has warpage, the light emitted from the first laser light source L1 provided by the first laser generator 31 can be precisely projected onto the engraved area 111 of the wafer W according to the first position information, so as to form an accurate and clear first predetermined pattern on the first engraved area 111.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A laser engraving device for engraving at least one wafer, comprising:
a carrier base carrying the at least one wafer, and at least one of the upper surfaces of the wafers having a first engraved area;
a position detecting module including a first transmitting component and a first receiving component, the first transmitting component and the first receiving component being disposed above the carrier base; and
a laser engraving module including a first laser generator disposed above the carrier base to provide a first laser source;
wherein the position detecting module cooperates with the first receiving component to provide a first position information of the first engraved area;
wherein the light emitted from the first laser light source provided by the first laser generator is precisely projected onto the first engraved area of at least one of the wafers according to the first position information, so as to form the first predetermined pattern on the first engraved area.

2. The laser engraving device according to claim 1, wherein the position detecting module and the laser engraving module are electrically connected to each other through a control module, and the position detecting module is one of an optical position sensor and an acoustic wave position sensor, wherein the first transmitting component is a first signal transmitting component generating a first detecting signal, and the first receiving component is configured to receive the first detecting signal, and the first detection signal generated by the first signal transmitting component is projected toward the first signal receiving component by reflection of the at least one wafer to provide the first engraved area of the first position information.

3. The laser engraving device according to claim 1, wherein the carrier base has a through opening, a lower surface of at least one of the wafers has a second engraved area disposed opposite to the first engraved area, and the second engraved area is exposed by the through opening, wherein the position detecting module includes a second transmitting component and a second receiving component, and the second transmitting component and the second receiving component are disposed below the carrier base, wherein the laser engraving module includes a second laser generator disposed below the carrier base to provide a second laser light source emitting light passing through the through opening, and wherein the detecting module cooperates with the second receiving component to provide a second position information of the second engraved area, the light emitted from the second laser light source provided by the second laser generator is precisely projected onto the second engraved area of at least one of the wafers according to the second position information, so as to form a second predetermined pattern on the second engraved area.

4. The laser engraving device according to claim 3, wherein the second transmitting component is a second signal transmitting component for generating a second detecting signal, and the second receiving component is a second signal receiving component to receive the second detecting signal generated by the second signal transmitting component, and the second detecting signal is projected toward the second signal receiving component by reflection of at least one of the wafers to provide the second position information of the second engraved area, wherein the first predetermined pattern is one of a mark, a trademark, a serial number, and a barcode, and the second predetermined pattern is one of a mark, a trademark, a serial number, and a barcode.

5. A laser engraving device for engraving at least one wafer, comprising:
a carrier base carrying at least one of the wafers, and at least one of the upper surfaces of the wafers having a first engraved area;
a first transmitting component disposed above the carrier base to provide a first laser light source;
a first receiving component being disposed above the carrier base; and
a control module electrically connected between the first transmitting component and the first receiving component;
wherein the light emitted from the first laser light source provided by the first transmitting component is projected toward the first receiving component by reflection of at least one of the wafers to provide a first position information of the first engraved area.

6. The laser engraving device according to claim 5, further comprising;
a first prism adjacent to the first transmitting component and the first receiving component;
a second prism adjacent to the first prism; and
a signal amplifier adjacent to the first prism;
wherein, the light emitted from the first laser light source generated by the first transmitting component sequentially passes through the first prism and the second prism to be projected to at least one of the wafers, the first laser light source forms a reflective light source by reflection of at least one of the wafers, and the reflected light source is sequentially projected to the first receiving component through the second prism and the first prism;
wherein the light emitted from the first laser light source generated by the first transmitting component is precisely projected onto the first engraved area of at least one of the wafers through the first prism and the signal amplifier.

7. A laser engraving device for engraving at least one wafer, comprising:
a carrier base carrying at least one of the wafers, and at least one of the upper surfaces of the wafers having a first engraved area;
a position detecting module including a first transmitting component and a first receiving component; and
a laser engraving module including a first laser generator disposed above the carrier base to provide a first laser source;
wherein the position detecting module cooperates with the first receiving component to provide a first position information of the first engraved area;
wherein the light emitted from the first laser light source provided by the first laser generator is precisely projected onto the first engraved area of at least one of the wafers according to the first position information, so as to form a first predetermined pattern on the first engraved area.

8. The laser engraving device according to claim 7, wherein the position detecting module and the laser engraving module are electrically connected to each other through a control module and the position detecting module is one of an optical position sensor and an acoustic wave position sensor, wherein the first transmitting component is a first signal transmitting component generating a first detecting signal, and the first receiving component is configured to receive the first detecting signal, and the first detection signal generated by the first signal transmitting component is projected toward the first signal receiving component by reflection of at least one of the wafers to provide the first engraved area of the first position information.

9. The laser engraving device according to claim 7, wherein the carrier base has a through opening, at least one lower surface of the wafer has a second engraved area disposed opposite to the first engraved area, and the second engraved area is surrounded and exposed by the through opening, wherein the position detecting module includes a second transmitting component and a second receiving component, and the second transmitting component and the second receiving component are disposed under the carrier base, wherein the laser engraving module includes a second laser generator disposed below the carrier base to provide a second laser light source emitting light passing through the through opening, and the position detecting module is coupled to the second receiving component by the second transmitting component to provide a second position information of the second engraved area, wherein the light emitted from the second laser light source provided by the second laser generator is precisely projected onto the second engraved area of at least one of the wafers according to the second position information, so as to form a second predetermined pattern on the second engraved area.

10. The laser engraving device according to claim 9, wherein the second transmitting component is a second signal transmitting component for generating a second detecting signal, and the second receiving component is a second signal receiving component for receiving the second detecting signal generated by the second signal transmitting component, and the second detecting signal is projected to the second signal receiving component by reflection of at least one of the wafers to provide the second position information of the second engraved area, wherein the first predetermined pattern is one of a mark, a trademark, a serial number, and a barcode, and the second predetermined pattern is one of a mark, a trademark, a serial number, and a barcode.
